(19) United States
(12) Patent Application Publication
(10) Pub. No.: US 2008/0151477 A1
(43) Pub. Date: Jun. 26, 2008

(54) HINGE FOR LAPTOP COMPUTER

(76) Inventor: Jr-Jiun Chern, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/614,437

(22) Filed: Dec. 21, 2006

(51) Int. Cl. G06F 1/16; E05C 17/64

(52) U.S. Cl. 361/681; 16/342

(57) ABSTRACT

A hinge is provided for a laptop computer. The hinge includes a first connector, a bush and a second connector. The first connector includes a root and a socket extended form the root. The root can be connected to a host of the laptop computer. The bush is fit in the socket so that the bush cannot be rotated in the socket. The second connector includes a shaft and a plate extended from the shaft. The shaft is wrapped by the bush. The plate can be connected to a liquid crystal display of the laptop computer.

### BACKGROUND OF INVENTION

1. Field of Invention

The present invention relates to a hinge and, more particularly, to a hinge for use in a laptop computer.

2. Related Prior Art

Referring to FIG. 8, a conventional hinge includes a first connector 1, a lining 2, an arched strip 3 and a second connector 4. The first connector 1 includes a solid portion connected to a host of the laptop computer and a hollow portion for receiving the lining 2. The lining 2 is hollow for receiving the arched strip 3. The second connector 4 includes a shaft wrapped by the arched strip 3 and a plate connected to a liquid crystal display of the laptop computer. The first connector 1 and the lining 2 are made separately and later joined together. To ensure proper joining, they must be manufactured with high precision so that the actual sizes thereof are close to the designed sizes thereof. However, this is a difficult and expensive process.

The present invention is therefore intended to obviate or at least alleviate the problems encountered in prior art.

### SUMMARY OF INVENTION

According to the present invention, a hinge is provided for a laptop computer. The hinge includes a first connector, a bush and a second connector. The first connector includes a root and a socket extended form the root. The root can be connected to a host of the laptop computer. The bush is fit in the socket so that the bush cannot be rotated in the socket. The second connector includes a shaft and a plate extended from the shaft. The shaft is rotationally inserted in the bush. The plate can be connected to a liquid crystal display of the laptop computer.

An advantage of the hinge according to the present invention is low cost for including only three parts.

Another advantage of the hinge according to the present invention is proper friction between the bush and the shaft.

Other advantages and features of the present invention will become apparent from the following description referring to the drawings.

### BRIEF DESCRIPTION OF DRAWINGS

The present invention will be described through detailed illustration of the preferred embodiment referring to the drawings.

FIG. 1 is a perspective view of a hinge according to the preferred embodiment of the present invention.

FIG. 2 is an exploded view of the hinge shown in FIG. 1.

FIG. 3 is a cross-sectional view of the hinge taken along a line 3-3 shown in FIG. 1.

FIG. 4 is a cross-sectional view of the hinge taken along a line 4-4 shown in FIG. 1.

FIG. 5 is a perspective view of a laptop computer equipped with two hinges as shown in FIG. 4.

FIG. 6 is a cross-sectional view of the hinge in another position than shown in FIG. 4.

FIG. 7 is a perspective view of a laptop computer equipped with two hinges as shown in FIG. 6.

FIG. 8 is an exploded view of a conventional hinge.

### DETAILED DESCRIPTION OF PREFERRED EMBODIMENT

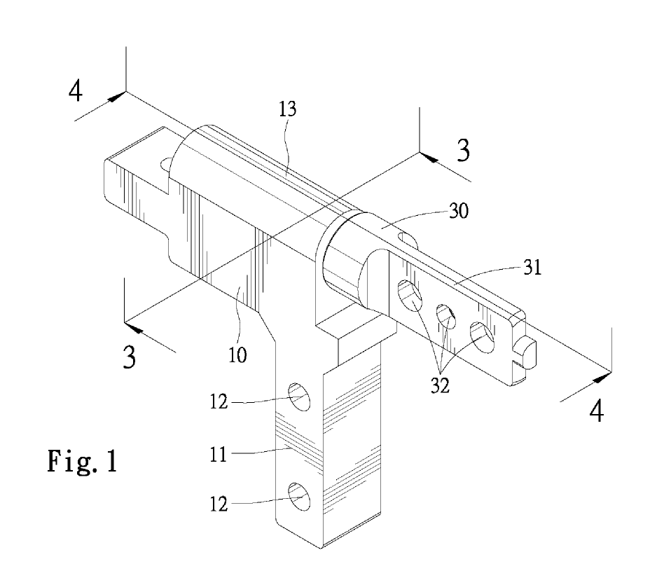

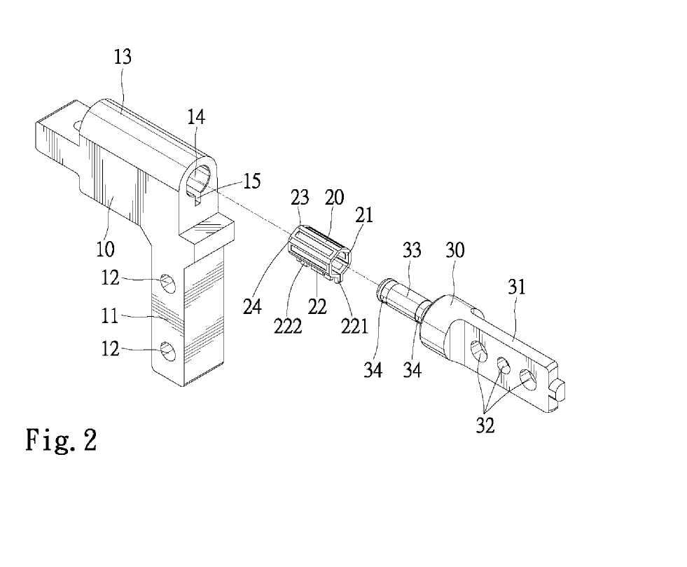

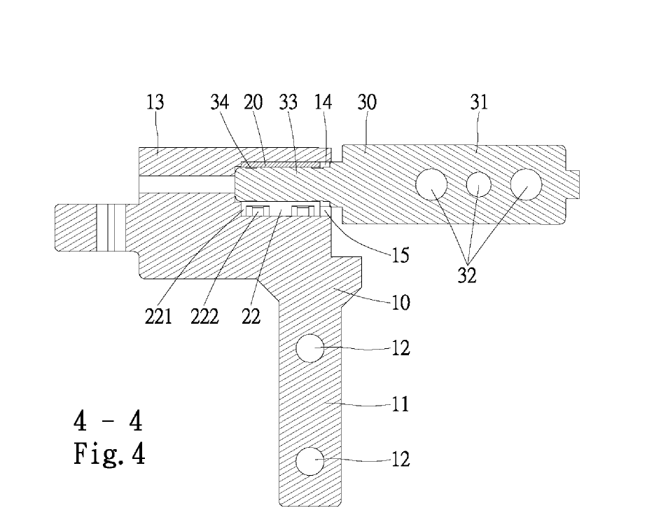

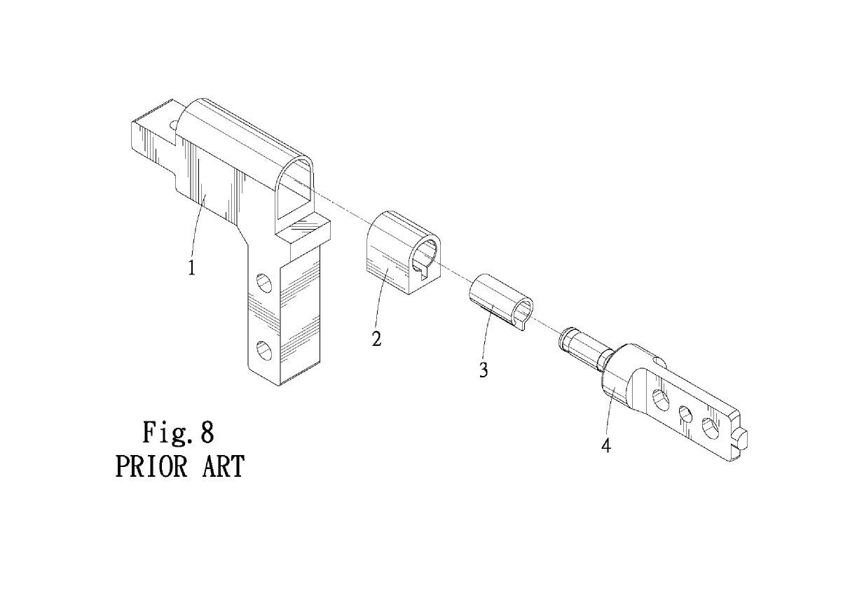

Referring to FIGS. 1 and 2, there is shown a hinge according to the preferred embodiment of the present invention. The hinge can be used in a laptop computer 40 including a host 41 and a liquid crystal display (“LCD”) 42 as shown in FIGS. 4 through 8. The hinge includes a first connector 10, a bush 20 and a second connector 30.

The first connector 10 includes a root 11 and a socket 13 transversely extended from the root 11. The root 11 defines two apertures 12 through which fasteners can be driven into the host 41 for connecting the root 11 to the host 41. The socket 13 defines a space 14 and a groove 15 in communication with the space 14.

The bush 20 includes a sleeve 21 and a positioning device 22 formed on the sleeve 21. A metal strip is rolled into the sleeve 21, with two edges made into the positioning device 22. The positioning device 22 includes pairs of tabs 221 and pairs of tabs 222. The tabs 221 are in contact with each other throughout their length. The tabs 222 are in contact with each other at an end but separated from each other at another end. The external side of the bush 20 includes a substantially polygonal profile with corners 24. The corners 24 are rounded for contact with the wall of the space 14. A trough 23 is defined between any two adjacent corners 24. Damping oil is filled in the troughs 23.

The second connector 30 includes a plate 31 and a shaft 33 axially extended from the plate 31. The plate 31 defines three apertures 32 through which fasteners can be driven into the LCD 42 for connecting the plate 31 to the LCD 42. The shaft 33 defines two annular grooves 34 for receiving damping oil.

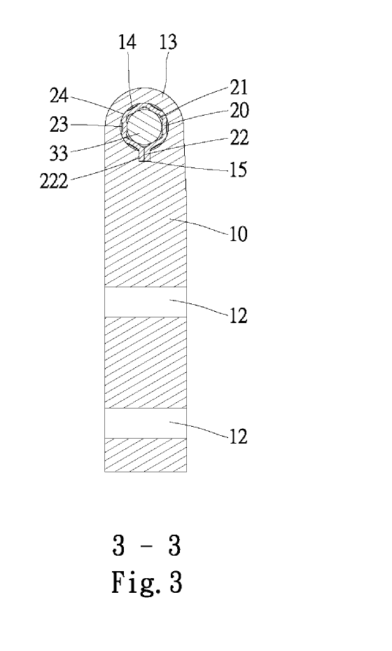

Referring to FIG. 3, the sleeve 21 is inserted in the space 14 while the positioning device 22 is fit in the groove 15. The rounded corners 24 are in contact with the wall of the space 14. The shaft 33 is inserted in the sleeve 21 so that the shaft 33 is wrapped by the sleeve 21. The damping oil exists between the shaft 33 and the sleeve 21. Thus, the shaft 33 is only allowed to rotate in the sleeve 21 slowly.

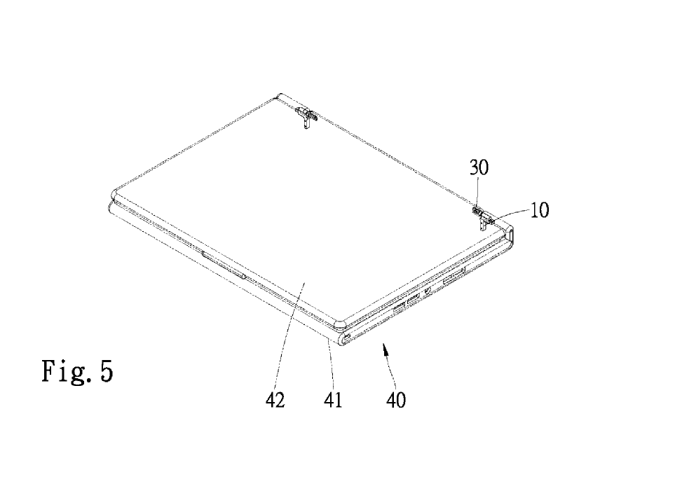

Referring to FIGS. 4 and 5, the LCD 42 is pivoted from the host 41. The LCD 42 can be kept in any desired position pivoted from the host 41 due to the use of the hinge.

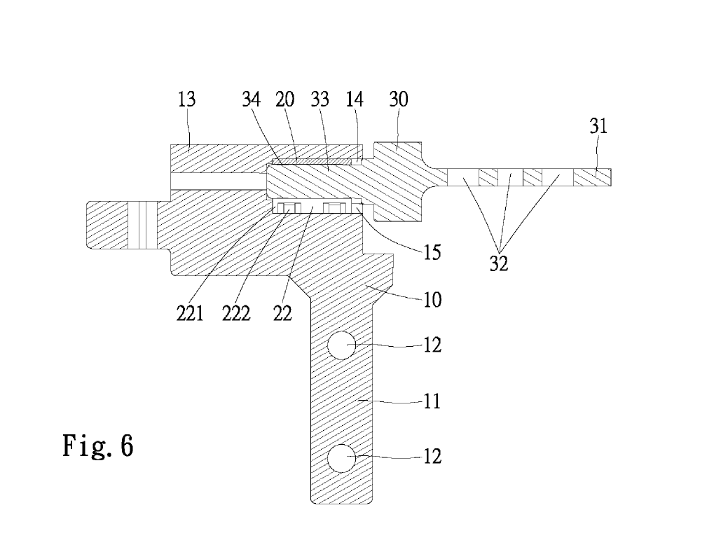

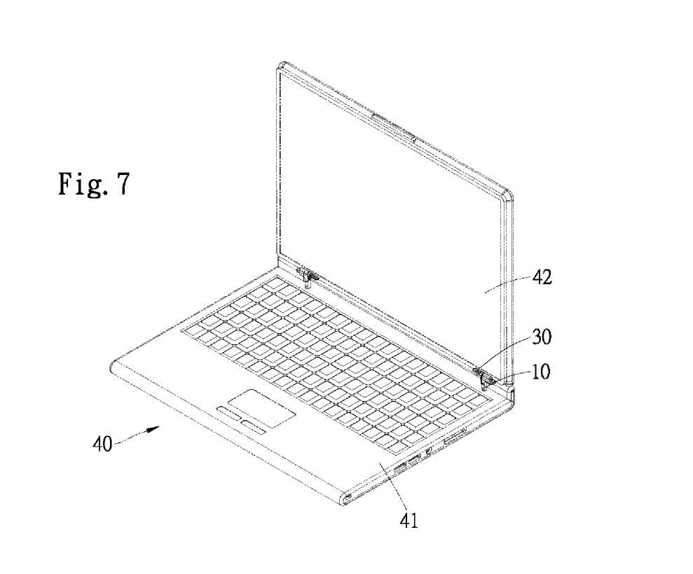

Referring to FIGS. 6 and 7, the LCD 42 is pivoted to and disposed on the host 41.

The hinge of the present invention exhibits advantages. Firstly, it is inexpensive for including only three parts. Secondly, there is proper friction between the bush 20 and the shaft 33.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A hinge for use in a laptop computer, the hinge comprising:
a first connector comprising a root for connection to a portion of the laptop computer and a socket extended form the root;
a bush fit in the socket so that the bush cannot be rotated in the socket; and
a second connector comprising a shaft rotationally inserted in the bush and a plate extended from the shaft for connection to another portion of the laptop computer.

2. The hinge according to claim 1 wherein the socket defines a space and a groove in communication with the space, and the bush comprises a sleeve fit in the space and a positioning device fit in the groove.

3. The hinge according to claim 2 wherein the positioning device comprises at one pair of parallel tabs.

4. The hinge according to claim 2 wherein the positioning device comprises at one pair of diverged tabs.

5. The hinge according to claim 2 wherein the positioning device comprises at one pair of parallel tabs and at least one pair of diverged tabs.

6. The hinge according to claim 1 wherein the sleeve comprises rounded corners in contact with an internal side of the socket.

7. The hinge according to claim 6 wherein the sleeve comprises a trough defined between any two adjacent ones of the rounded corners for containing damping oil.

8. The hinge according to claim 1 wherein the shaft defines at least one annular groove for containing damping oil.

9. The hinge according to claim 8 wherein the shaft defines two annular grooves.

10. The hinge according to claim 1 wherein the first connector is manufactured by powder metallurgy.
